(19) United States
(12) Patent Application Publication
(10) Pub. No.: US 2002/0040387 A1
(43) Pub. Date: Apr. 4, 2002

(54) Method for tracing an electronic mail message

(76) Inventors: Andre Santos Lessa, Pittsburgh, PA (US); Marcos Baptista Moraes Machado, Rio de Janeiro (BR)

Correspondence Address: BUCHANAN INGERSOLL, P.C., 301 GRANT STREET, 20TH FLOOR, PITTSBURGH, PA, 15219

(21) Appl. No.: 09/682,632

(22) Filed: Oct. 1, 2001

Related U.S. Application Data
(60) Provisional application No. 60/236,530, filed on Sep. 29, 2000.

(51) Int. Cl. G06F 15/16

(52) U.S. Cl. 709/206

(57) ABSTRACT

A method for tracing an electronic mail message to determine when the recipient has opened the message is disclosed. A server is provided which intercepts e-mail messages intended for the recipient. The server modifies the e-mail to add HTML code to the message and forwards the message to the recipient. The HTML code causes the recipient's mail client program to request a file from the server. When the server detects the request, it knows that the mail message has been opened and thereafter informs the sender. Several other embodiments are also disclosed.

### RELATED APPLICATIONS

### REFERENCED-APPLICATIONS

This application claims the benefit of U.S. provisional application serial No. 60/236,530 filed on Sep. 29, 2000.

### FIELD OF THE INVENTION

This invention relates to the field of electronic mail, or e-mail, and provides a method whereby a sender of an e-mail can detect when the intended recipient has opened the e-mail message.

### BACKGROUND OF INVENTION

The concept of the sender of a message receiving notification when the message has been received by the recipient is well known in the prior art. In the non-electronic world it is possible to send mail “certified” or “return receipt requested” to receive confirmation that the message has reached its destination. Likewise, in the domain of electronic mail, users in a homogeneous environment, such as on an intranet where all users are using the same email program, are able to track the read/unread status of sent e-mails or to receive notification via a return e-mail message when the recipient has read the message.

A problem arises, however, when a user desires to receive notification of the receipt of an e-mail message sent over the Internet. First, the mechanism by which e-mail messages get delivered over the internet may involve a circuitous path between the sender and the recipient during which the message may pass through dozens of intermediate computer systems. Having a return message re-trace this path may be impossible. Second, users on different systems may be using different e-mail programs having incompatible methods of sending notification. Most likely, because of the delivery mechanism over the Internet, any notification system would have to be initiated by the e-mail program of the recipient, and would thus be controlled by the recipient, allowing the recipient to enable or disable this feature at his whim. As a result, a request by the sender of an e-mail for receipt notification may be ignored by the recipient's e-mail program, resulting in no return message to the sender.

It would therefore be desirable to allow the sender of an e-mail to a recipient via the Internet to request a receipt notification, and to have that notification delivered to the sender without the knowledge of the recipient of the original e-mail message.

### SUMMARY OF THE INVENTION

In its preferred embodiment, the notification system disclosed herein makes use of an intermediate system able to communicate with both the sender and the recipient via the Internet. In use, the sender directs the outgoing e-mail message to the intended recipient via the intermediary. The intermediary adds a fragment of hypertext mark-up language (HTML) code to the message and forwards it onto the intended recipient. When the recipient opens the message, the HTML code is executed. The HTML code causes the recipient's email program to contact the intermediary in search of a file. When the intermediary receives the request for the file, it knows that the recipient has opened the e-mail message and a notification e-mail message is sent to the sender of the original e-mail message, thereby providing the requested notification.

### DESCRIPTION OF DRAWINGS

FIG. 1 shows the flow of a message according to the preferred embodiment of the invention.

FIG. 2 shows the preferred and several secondary embodiments of the invention.

### DETAILED DESCRIPTION OF THE INVENTION

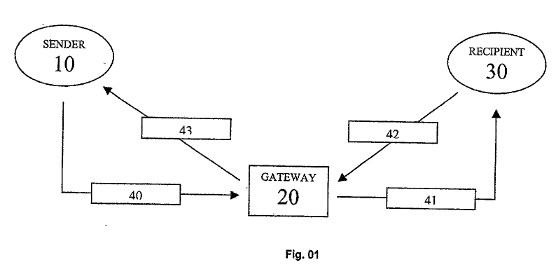

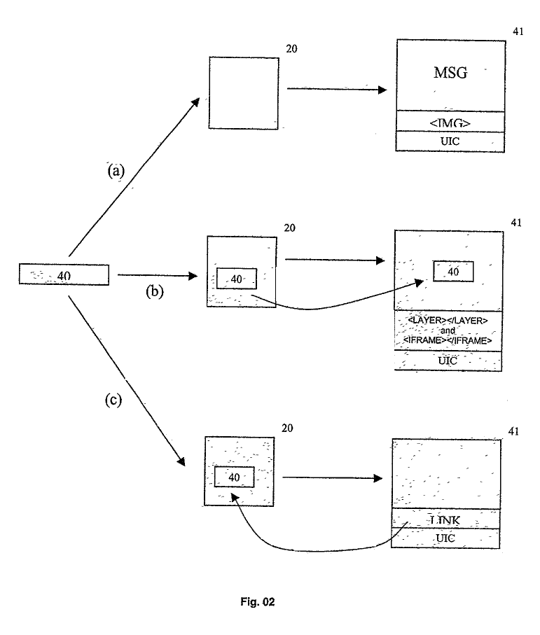

The preferred embodiment of the invention is shown schematically in FIG. 1 and as path (a) in FIG. 2, and will now be described. The user that sends the message (the “sender”) 10 will create an e-mail message 40 using their local e-mail program. Sender 10 therefore supplies the following information: the e-mail address of recipient 30, the message subject, the message's body text, and optionally, any file attachments.

There exists a gateway system 20, which is best described as an address or web site accessible from the Internet, on which is running a program that receives all incoming e-mail messages 40 and handles those messages according to a set of criteria. For gateway system 20 to receive the e-mail message 40 it is necessary for sender 10 of the e-mail to modify the address of recipient 30 such that the e-mail message 40 is routed through gateway system 20. When entering the e-mail address of recipient 30 in his/her local mail-client application, the sender needs to replace the symbol @ with the symbol “#”, append the symbol “@” to the end of the e-mail address, and append the name of the domain of the gateway, which, for purposes of this disclosure, we will refer to as simply “gateway.com” to the end of the e-mail address of recipient 30. As an example, if sender 10 wanted to send an e-mail to a user named “bob” at domain “isp.net” the address would normally be:

“bob@isp.net”

For purposes of this invention, sender 10 would instead send e-mail message 40 to:

“bob#isp.net@gateway.com”

Once gateway system 20 receives e-mail message 40, it splits the message fields: FROM, TO, SUBJECT, and the message body, which may or may not contain attached files. The message field TO must be correctly formatted in order to be redirected according to what is proposed by the system. The system is in charge of taking the given value and converting it into the real format of the e-mail address of recipient 30, in this exemplary case, “bob@isp.net”. This treatment consists of replacing the symbol “#” with the symbol “@”, and removing the extension “@gateway.com.”

Based on the information provided in the FROM field, gateway system 20 is able to identify the e-mail address of sender 10. This address is stored locally on gateway system 20.

Each e-mail message 40 received by gateway system 20 is assigned a unique identification code (UIC), which is randomly generated by gateway system 20 based on specific timestamp and session variables. The UIC is stored locally on gateway system 20 and is associated with the e-mail address of sender 10.

The message body of e-mail message 40 is converted to HTML format and a special HTML <IMG> tag is added to the HTML code. The <IMG> is tag is a standard HTML tag that is usually used to display images on a web page, but for the purpose of this invention, it is being used in a very different way. Instead of setting the <IMG> attribute SRC, which would normally point to an file containing the image to be displayed, to point to an image, we are setting it to point to a specific CGI-SCRIPT, and we are passing to the CGI-SCRIPT, as an argument, the UIC that we have just created to identify the message. The <IMG> tag containing the call to the CGI-SCRIPT would look something like this:

<IMG SRC=“http://www.gateway.com/script.cig?p=al3939ajsdl38476” HEIGHT=1 WIDTH=1>

Note that the HEIGHT and the WIDTH of the tag are set to 1, such that recipient 30 will not actually see an image. It is also important to note that in order for this CGI-SCRIPT to work, its parsing routine needs to work using GET mode, instead of using POST mode. Note that this tag contains the UIC that was previously explained in this same document.

The customized <IMG> tag is added to the body of message 41 (actually to the first part of the message body, because in case of multi-part/mixed messages, the first part is the part that contains the text message), and message 41 is sent to recipient 30 using a mail program (such as sendmail). This program sends message 41 to the e-mail address of recipient 30 as an HTML message using the MIME TYPE text/html, not as an HTML file attachment.

Next, any attachments to original e-mail message 40 message are attached to this processed message 41. Then, message 41 is sent to the e-mail address of recipient 30. Note that the message's header must be set to text/html to force recipient's mail-client to read message 41 as if it were an HTML file.

Once recipient 30 opens e-mail message 41, the <IMG> HTML tag is executed, and the mail reader attempts to execute a CGI-SCRIPT which was named using the UIC associated with original e-mail message 40. The UIC was passed as the SRC attribute in the <IMG> tag, which was added to e-mail message 42 by gateway server 20. The recipient's mail reader then makes a request 42 to gateway server 20 to execute the CGI-SCRIPT. Gateway system 20 detects request 42 and retrieves the address of sender 10 of original e-mail message 40, which is also associated with the UIC. Using this address, gateway system 20 sends an e-mail message 43 back to sender 10 notifying him that original message 40 has been opened by recipient 30. Notification e-mail message 43 can contain, among other things, the date and time that e-mail message 41 was opened by recipient 30 and the number of times that recipient 30 has opened the e-mail. In another embodiment of the invention, sender 10 may be able to indicate that no notification e-mails are to be sent back to sender 10. Instead, the sender 10 may access gateway server 20 via a web interface to check the status of messages that he has sent via gateway server 20.

Note that an extra HTML file is NOT attached to message 41. Instead, it is merely indicated that the body of message 41 is text that should be interpreted as HTML. By taking advantage of this format, recipient 30 does not have an attachment to open and to analyze. Therefore, as soon as recipient 30 opens e-mail message 41, the tag is interpreted, the CGI-SCRIPT is called, and the UIC is activated.

In a second embodiment of the invention sender 10 can send an e-mail message 40 to recipient 30 using a web-based interface. If, for some reason, sender 10 can't access his personal e-mail application, gateway system 20 may provide a web interface that allows the user to send a message directly through the system interface. Sender 10 accesses gateway system 20 and fills out a basic form containing his personal information such as (but not limited to) name, e-mail address, country, and so forth. A login name and password is defined for sender 10. Whenever sender 10 wishes to send an e-mail to someone, he opens the web mail form, and provides the necessary information discussed above, that will become part of his message. Note that the web mail form requires that sender 10 provide his login and password. Once sender 10 presses the confirmation button, a UIC is created for the message, the <IMG> tag containing the UIC is appended to body of the message, and the message is sent to recipient 30.

In a third embodiment of the invention, the responsibility for executing the CGI-SCRIPT is moved from the recipient's web browsers/e-mail readers to gateway system 20. This embodiment may be used in situations where a firewall or other preventative measure blocks the use of <IMG> tags to call scripts. To handle this situation the <IMG> tag is modified to replace the call to the CGI-SCRIPT with the name of an actual image file, such as, for example:

<IMG SRC=“http://www.gateway.com/fakeimages/UIC.gif” HEIGHT=1 WIDTH=1 >

Where “UIC’ is the actual UIC that was send with message 41 to recipient 30. Any type of image file, commonly known to those of skill in the art, such as .gif, .jpg, .tif and so forth could be used. The image file will not actually exist on gateway server 20, but a special configuration on gateway server 20 will redirect all HTTP GET calls to a given directory (in this case “/fakeimages”) to a server script. The server script reads the web server environment variables, and identifies the path of the image that the recipient's e-mail reader is trying to access. Internally, the script strips the UIC from the image name referenced in that call. Then, by checking the UIC against those stored locally, the script is able to validate the code and set a flag indicating that message 41 has been opened by recipient 30. The last thing the script does is to return a static image to the recipient's mail reader, which ideally (but not necessarily) has 1 pixel per 1 pixel dimensions. This action is important to make sure the browser receives the image it expects.

In yet another embodiment of the invention, message 40 is stored on gateway server 20. Recipient 30 when opening e-mail message 41 triggers an automatic request to gateway server 20 that causes message 40 to be displayed to recipient 30. Message 40 appears to be embedded in the e-mail message 41 that is already opened. When the request from recipient 30 is received by gateway server 20, the notification procedure outlined in the preferred embodiment of the invention is triggered. This method is shown graphically as path b in FIG. 2. In this embodiment, original message 40 sent by sender 10 must be kept locally by gateway server 20. This embodiment of the invention uses the <LAYER></LAYER> and the <IFRAME></IFRAME> tags to dynamically embed original message 40 into e-mail message 41, as the result of an automatic request made to gateway server 20. E-mail message 41 sent to recipient 30 may look like this:

<HTML>

<HEAD></HEAD>

<BODY>

<LAYER NAME=“message” SRC=LINK TO MESSAGE>

<IFRAME ID=“message” SRC=LINK TO MESSAGE WIDTH=100% NORESIZE

SCROLLING=No FRAMEBORDER=0 MARGINHEIGHT=0 MARGINWIDTH=0>

</IFRAME>

</LAYER>

</BODY>

</HTML>

where LINK TO MESSAGE is actually a PATH to the CGI script which will show the stored message. The script will receive the UIC as an argument. When the request is received by gateway server 20, it is an indication that recipient 30 has opened e-mail message 41.

In a final embodiment of the invention, message 40 is stored on gateway server 20 and an e-mail message 41 is sent to recipient 30 which contains an HTML link to original message 40. When recipient 30 opens the message, he must click on the link which will cause the original message 40 to be displayed either in the recipient's e-mail reader or in a web browser. The HTML request is detected by gateway server 20 and thereby triggering the original notification procedure outlined in the preferred embodiment of the invention. This embodiment is shown graphically as path (c) in FIG. 2. As with the previous embodiment, original message 40 sent by sender 10 must be kept locally by gateway server 20.

The specific examples used herein to illustrate the invention should not be considered as limiting the invention thereto. As can be seen in one skilled in the art, different modifications of the basic techniques could be implemented without deviating from the spirit of the invention. As a result, the scope of the invention is as claimed in the following claims.

1. A method for tracing an e-mail message comprising the steps of:
providing a server able to communicate with a first computer system from which a first e-mail message is sent by a sender and with a second computer system from which said first e-mail message is received by a recipient.
receiving said first e-mail message sent by said sender for said recipient;
sending a second e-mail message to said recipient;
detecting when said recipient opens said second e-mail message; and
informing said sender that said recipient has opened said second e-mail message.

2. The method of claim 1 further comprising the step of modifying said first e-mail message to create said second e-mail message.

3. The method of claim 2 wherein said modification causes said second computer system to search for a file on said server when said recipient opens said second e-mail message.

4. The method of claim 3 wherein said modification comprises the steps of:
converting said first e-mail message to HTML format; and
adding additional HTML code to said first e-mail message.

5. The method of claim 4 wherein said additional HTML code is an <IMG> command.

6. The method of claim 5 wherein said <IMG> command causes said second computer system to execute a script on said server.

7. The method of claim 6 further comprising the steps of:
detecting the request from said second computer system for said script; and
using said request as an indication that said recipient has opened said second e-mail message.

8. The method of claim 5 wherein said <IMG> command causes said second computer system to search for an image file on said server, further comprising the steps of:
detecting the request from said second computer system for said image file;
using said request as an indication that said recipient has opened said second e-mail message; and
sending a dummy image file to said second computer system in response to said request.

9. The method of claim 1 further comprising the steps of:
storing on said server the e-mail address of said sender of said first e-mail message;
creating a unique identification code;
associating said unique identification code with said e-mail address of said sender; and
including said unique identification code with said second e-mail message.

10. The method of claim 9 wherein said detecting step further comprises the step of waiting to receive a request from said second computer system, said request in some way containing said unique identification code.

11. The method of claim 10 further comprising the steps of:
retrieving said sender's e-mail address through said association with said received unique identification code; and
informing said sender that said recipient has opened said second e-mail message.

12. The method of claim 1 wherein said informing step comprises the step of sending a third e-mail message to said sender.

13. The method of claim 12 wherein said third e-mail message includes the date and time that said recipient opened said second e-mail message.

14. The method of claim 1 wherein said informing step comprises the step of posting a notification on a web site accessible to said sender.

15. The method of claim 14 wherein said posting includes the date and time that said recipient opened said second e-mail message.

16. The method of claim 1 further comprising the steps of:
storing said first e-mail message on said server; and
creating said second e-mail message, said second e-mail message containing a link to said stored first e-mail message.

17. The method of claim 16 wherein said second e-mail message contains instructions for said recipient to access said stored first e-mail message by selecting said included link.

18. The method of claim 1 7 further comprising the steps of:
detecting when said stored first e-mail message is requested by said second computer system; and
using said request as an indication that said recipient has opened said second e-mail message.

19. The method of claim 1 further comprising the steps of:
storing said first e-mail message on said server; and
creating said second e-mail message, said second e-mail message containing an embedding call to said stored first e-mail message, such that said first e-mail message is automatically displayed as an embedded document in said second e-mail message when said recipient opens said second e-mail message.

20. The method of claim 19 further comprising the steps of:
detecting when said stored first e-mail message is requested by said second computer system; and
using said request as an indication that said recipient has opened said second e-mail message.

21. A method for tracing an e-mail message comprising the steps of:
providing a server having an interface accessible as a web page;
allowing a sender of an e-mail message to access said server via said interface to compose a first e-mail message for a recipient on a computer system with which said server is able to communicate;
sending a second e-mail message to said recipient;
detecting when said recipient opens said second e-mail message; and
informing said sender that said recipient has opened said second e-mail message.

22. The method of claim 21 further comprising the step of creating said second e-mail message, said second e-mail message containing said first e-mail message plus additional HTML code.

23. The method of claim 22 wherein said additional HTML code causes the recipient's computer system to search for a file on said server when said recipient opens said second e-mail message.

24. The method of claim 23 wherein said additional HTML code is an <IMG> command.

25. The method of claim 23 further comprising the steps of:
detecting attempts by said recipient's computer system to request said file on said server; and
using said request as an indication that said recipient has opened said second e-mail message.

26. The method of claim 21 further comprising the steps of:
storing said first e-mail message on said server; and
creating said second e-mail message, said second e-mail message containing a link to said stored first e-mail message.

27. The method of claim 26 wherein said second e-mail message contains instructions for said recipient to access said stored first e-mail message by selecting said included link.

28. The method of claim 27 further comprising the steps of:
detecting when said stored first e-mail message is requested by said second computer system; and
using said request as an indication that said recipient has opened said second e-mail message.

29. The method of claim 21 further comprising the steps of:
storing said first e-mail message on said server; and
creating said second e-mail message, said second e-mail message containing an embedding call to said stored first e-mail message, such that said first e-mail message is automatically displayed as an embedded document in said second e-mail message when said recipient opens said second e-mail message.

30. The method of claim 29 further comprising the steps of:
detecting when said stored first e-mail message is requested by said second computer system; and
using said request as an indication that said recipient has opened said second e-mail message.
